(19) United States
(12) Patent Application Publication
(10) Pub. No.: US 2021/0203256 A1
(43) Pub. Date: Jul. 1, 2021

(54) MOTOR DRIVER AND REFRIGERATION CYCLE EQUIPMENT

(71) Applicant: Mitsubishi Electric Corporation, Tokyo (JP)

(72) Inventors: Shinya TOYODOME, Tokyo (JP); Kazunori HATAKEYAMA, Tokyo (JP); Yuichi SHIMIZU, Tokyo (JP)

(21) Appl. No.: 17/056,735

(22) PCT Filed: Jun. 18, 2018
(86) PCT No.: PCT/JP2018/023062

§ 371 Date: Nov. 18, 2020

(51) Int. Cl. H02P 5/46; F25B 31/02

(52) U.S. Cl. CPC H02P 5/46; F25B 31/026

(57) ABSTRACT

There are provided an inverter connected to n (n being as integer not less than 2) motors each including a rotor having a permanent magnet and capable of driving the n motors, and a connection switching device to switch a connection state of at least one motor of the n motors and the inverter between connection and disconnection. While the n motors are connected to the inverter and driven by the inverter, when an abnormality is detected in the at least one motor, the connection switching device switches the connection state to the disconnection and the inverter drives the n motors except the at least one motor.

### CROSS REFERENCE TO RELATED APPLICATION

This application is a U.S. national stage application of International Patent Application No. PCT/JP2018/023062 filed on Jun. 18, 2018, the disclosure of which is incorporated. herein by reference.

### TECHNICAL FIELD

This relates to a motor driver and refrigeration cycle equipment.

### BACKGROUND

There is a conventional technique of driving two or more motors with a single inverter. For example, Patent Literature 1 describes a control method in a power converter to which two permanent magnet synchronous motors are connected in parallel with each other.

### CITATION LIST

### Patent Literature

Patent Literature 1: Japanese Patent No. 6067747

In the conventional technique, when one of the two or more motors enters an abnormal state due to disturbance or the like, the operation of the normal motor(s) also needs to be stopped.

### SUMMARY

One or more aspects of the present invention have been made in view of the above, and are intended to make it possible, when one of two or more motors enters an abnormal state due to disturbance or the like, to continue to cause the normal motor(s) to operate.

A motor driver according to an aspect of the present invention includes: an inverter connected to n motors each including a rotor having a permanent magnet and capable of driving the n motors, n being an integer not less than 2; and a connection switching device to switch a connection state of at least one of the n motors and the inverter between connection and disconnection, wherein while the n motors are connected to the inverter and driven by the inverter, when an abnormality is detected in the at least one motor, the connection switching device switches the connect on state to the disconnection and the inverter drives the n motors except the at least one motor.

According to one or more aspects of the present invention, when one of two or more motors enters an abnormal state due to disturbance or the like, by disconnecting the motor in the abnormal state, it is possible to continue to cause the normal motor(s) to operate.

### BRIEF DESCRIPTION OF DRAWINGS

FIG. 1 as a schematic diagram illustrating a motor driver of a first embodiment.

FIG. 2 is a functional block diagram illustrating a configuration of a controller in the first embodiment.

FIGS. 3A to 3C are diagrams illustrating operation of a PWM signal generator of FIG. 2.

FIG. 4 is a schematic diagram illustrating a first usage example of the motor driver of the first embodiment.

FIG. 5 is a schematic diagram illustrating a second usage example of the motor driver of the first embodiment.

FIG. 6 is a schematic diagram illustrating a third usage example of the motor driver of the first embodiment.

FIG. 7 is a schematic diagram illustrating a motor driver of a second embodiment.

FIG. 8 is a functional block diagram illustrating a configuration of a controller in the second embodiment.

FIG. 9 as a schematic diagram illustrating a first usage example of the motor driver of the second embodiment.

FIG. 10 is a schematic diagram illustrating a second usage example of the motor driver of the second embodiment.

FIG. 11 is a schematic diagram illustrating a third usage example of the motor driver of the second embodiment.

FIG. 12 is a circuit configuration diagram of a heat pump apparatus according to a third embodiment.

FIG. 13 is a Mollier chart regarding the state of a refrigerant in the heat pump apparatus according to the third embodiment.

FIG. 14 as a schematic diagram illustrating an example of a case where three motors are connected to an inverter.

### DETAILED DESCRIPTION

The following describes motor drivers according to embodiments, and refrigeration cycle equipment provided therewith, with reference to the attached drawings. The present invention is not limited by the following embodiments.

### First Embodiment

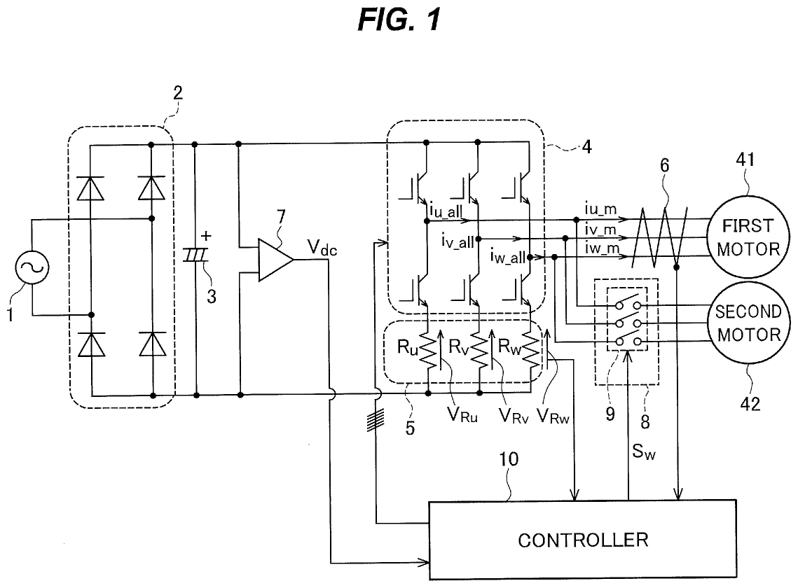

FIG. 1 is a schematic diagram illustrating a motor driver of a first embodiment. The motor driver is for driving first and second permanent magnet synchronous motors 41 and 42. Hereinafter, the “permanent magnet synchronous motor” may be referred to simply as a “motor”.

The illustrated motor driver includes a rectifier 2, a smoothing device 3, an inverter 4, an inverter current detector 5, a motor current detector 6, an input voltage detector 7, a connection switching device 8, and a controller 10.

The rectifier 2 rectifies alternating current (AC) power from an AC power supply 1 to generate direct-current (DC) power.

The smoothing device 3, which is formed by a capacitor or the like, smooths the DC power from the rectifier 2 and supplies it to the inverter 4.

The AC power supply 1 is single-phase in the example of FIG. 1, but may be a three-phase power supply. When the AC power supply 1 is three-phase, a three-phase rectifier is used as the rectifier 2.

As the capacitor of the smoothing device 3, an aluminum electrolytic capacitor, which has large capacitance, is often used in general, but a film capacitor, which is long-life, may be used. A small-capacity capacitor may be used to reduce harmonics of a current flowing through the AC power supply 1.

Also, a reactor (not illustrated) may be inserted between the AC power supply 1 and the smoothing device 3, in order to reduce harmonic currents or improve the power factor.

The inverter 4 receives the voltage across the smoothing device 3, and outputs a three-phase AC power of variable frequency and variable voltage value.

The first motor 41 and second motor 42 are connected in parallel with each other to the out of the inverter 4.

In the illustrated example, the connection switching device 8 is formed by a single switch 9. The switch 9 can connect and disconnect the second motor 42 to and from the inverter 4. By opening and closing the switch 9, the number of the motors which are concurrently operated can be changed.

As semiconductor switching elements constituting the inverter 4, insulated gate bipolar transistors (IGBTs) or metal oxide semiconductor field effect transistors (MOSFETs) are often used.

To reduce surge voltages due to switching of the semiconductor switching elements, freewheeling diodes (not illustrated) may be connected in parallel with the semiconductor switching elements.

Parasitic diodes of the semiconductor switching elements may be used as the freewheeling diodes. In the case of MOSFETs, it is possible to provide functions similar to those of the freewheeling diodes by turning on the MOSFETs at the time of back-flow.

The material forming the semiconductor switching elements is not limited so silicon (Si), but may be wide-bandgap semiconductor, such as silicon: carbide (SiC) , gallium nitride (GaN), gallium oxide (Ga₂O₃), or diamond. By using wide-bandgap semiconductor, it is possible to reduce the power loss and increase the switching speed.

As the switch 9, an electromagnetic contactor, such as a mechanical relay or a contactor, may be used instead of a semiconductor switching element. In summary, any type of device having a similar function may be used.

In the illustrated example, the switch 9 is provided between the second motor 42 and the inverter 4. Alternatively, the switch 9 may be provided between the first motor 41 and the inverter 4. Two switches may be provided, with one between the first motor 41 and the inverter 4, and the other between the second motor 42 and the inverter 4. When two switches are provided, the two switches constitute the connection switching device 8.

The inverter current detector 5 detects currents flowing through the inverter 4. In the illustrated example, the inverter current detector 5 determines currents (inverter currents) i_{u_all}, i_{v_all}, i_{w_all} of the respective phases of the inverter 4, based on the voltages V_{Ru}, V_{Rv}, V_{Rw} across resistors Rᵤ, Rᵥ, R_{w} connected in series with respective switching elements of three lower arms of the inverter 4.

The motor current detector 6 detects currents of the first motor 41. The motor current detector 6 includes three current transformers that detect respective currents (phase currents) i_{u_m}, i_{v_m}, i_{w_m} of the three phases.

The input voltage detector 7 detects an input voltage (DC bus voltage) V_{dc} of the inverter 4.

The controller 10 outputs signals for operating the inverter 4, based on the current values detected by the inverter current detector 5, the current values detected by the motor current detector 6, and the voltage value detected by the input voltage detector 7.

In the above-described example, the inverter current detector 5 detects the currents of the respective phases of the inverter 4, using the three resistors connected in series with the switching elements of the lower arms of the inverter 4. Alternatively, it may detect the currents of the respective phases of the inverter 4, using a resistor connected between a common junction of the switching elements of the lower arms and a negative electrode of the capacitor as the smoothing device 3.

Also, in addition to the motor current detector 6 for detecting the currents of the first motor 41, a motor current detector for detecting currents of the second motor 42 may be provided.

For the detection of the motor currents, it is possible to use, instead of the current transformers, Hall elements or a configuration in which each current is calculated from the voltage across a resistor.

Similarly, for the detection of the inverter currents, it is possible to use current transformers, Hall elements, or the like, instead of the configuration in which each current is calculated from the voltage across a resistor.

The controller 10 can be implemented by processing circuitry. The processing circuitry may be implemented by, dedicated hardware, software, or a combination of hardware and software. When implemented by software, the controller 10 can be formed by a microcomputer including a central processing unit (CPU), a digital signal processor (DSP), or the like.

FTG. 2 is a functional block diagram illustrating a configuration of the controller 10.

As illustrated, the controller 10 includes an operation command unit 101, a subtractor 102, coordinate converters 103, 104, speed estimators 105, 106, integrators 107, 108, a voltage command generator 109, a ripple compensation controller 110, a coordinate converter 111, a PWM signal generator 112, and a motor abnormality detector 113.

The operation command unit 101 generates and outputs a rotational frequency command value ωₘ* for the motors. The operation command unit 101 also generates and outputs a switching control signal S_{w} for controlling the connection switching device 8.

The subtractor 102 subtracts the phase currents i_{i_m}, i_{v_m}, i_{w_m} of the first motor 41 from the phase currents i_{u_all}, i_{v_all}, i_{w_all} of the inverter 4 detected by the inverter current detector 5, to determine phase currents i_{u_sl}, i_{v_sl}, i_{w_sl} of the second motor 42.

This utilizes the relation that the sums of the phase currents i_{u_m}, i_{v_m}, i_{w_m} of the first motor 41 and the phase currents i_{u_sl}, i_{v_sl}, i_{w_sl} of the second motor 42 are equal to the phase currents i_{u_all}, i_{v_all}, i_{w_all} of the inverter.

The coordinate converter 103 determines dq-axis currents i_{d_m}, i_{q_m} of the first motor 41, by performing coordinate conversion of the phase currents i_{u_m}, i_{v_m}, i_{w_m} of the first motor 41 from a stationary three-phase coordinate system to a rotational two-phase coordinate system, using a phase estimated value (magnetic pole position estimated value) θₘ of the first motor 41, to be described later.

The coordinate converter 104 determines dq-axis currents i_{d_sl}, i_{q_sl} of the second motor 42, by performing coordinate conversion of the phase currents i_{u_sl}, i_{v_sl}, i_{w_sl} of the second motor 42 from a stationary three-phase coordinate system to a rotational two-phase coordinate system, using a phase estimated value (magnetic pole position estimated value) θₛₗ of the second motor 4, to be described later.

The first motor speed estimator 105 determines a rotational frequency estimated value ωₘ of the first motor 41, based on the dq-axis currents i_{d_m}, i_{q_m} and dq-axis voltage command values v_{d}* v_{q}* to be described later.

Similarly, the second motor speed estimator 106 determines a rotational frequency estimated value ωₛₗ i of the second motor 42, based on the dq-axis currents i_{d_sl}, i_{q_sl} and the dq-axis voltage command values v_{d}*, v_{q}* to be described later.

The integrator 107 integrates the rotational frequency estimated value ωₘ of the first motor 41 to determine the phase estimated value θₘ of the first motor 41.

Similarly, the integrator 108 integrates the rotational frequency estimated value ωₛₗ of the second motor 42 to determine the phase estimated value θₛₗ of the second motor 42.

For the estimation of the rotational frequencies and the phases, the method described in Japanese Patent No. 4672236, for example, may be used. However, any other method for estimating the rotational frequencies and the phases may be used. A method for directly detecting the rotational frequencies or the phases may also be used.

The voltage command generator 109 calculates the dq-axis voltage command values v_{d}* v_{q}* based on the dq-axis currents i_{d_m}, i_{q_m} of the first motor 41, the rotational frequency estimated value ωₘ of the first motor 41, and a ripple compensation current command value iₛₗ* to be described later.

The coordinate converter 111 determines an applied voltage phase θᵥ, from the phase estimated value θₘ of the first motor 41 and the dq-axis voltage command values v_{d}*, v_{q}*, and determines voltage command values vᵤ*, vᵥ*, v_{w}* in the stationary three-phase coordinate system, by performing coordinate conversion of the dg-axis voltage command values v_{d}*, v_{q}* from the rotational two-phase coordinate system to the stationary three-phase coordinate system, based on the applied voltage phase θᵥ.

For example, the applied voltage phase θᵥ can be obtained by adding a leading phase angle θ_{f} to the phase estimated value θₘ of the first motor 41, the leading phase angle θ_{f} being obtained from the dq-axis voltage command values v_{d}* v_{q}* by

θ_{f}=tab⁻¹ (v_{q}*/v_{d}*).

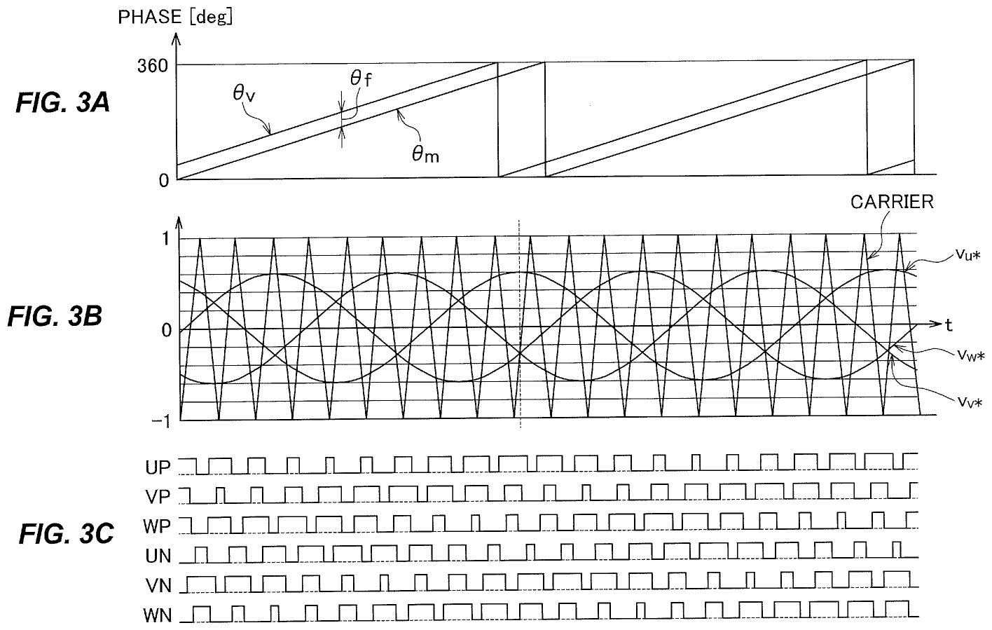

FIG. 3A illustrates an example of the phase estimated value θₘ, the leading phase angle θ_{f}, and the applied voltage phase θᵥ, and FIG. 3B illustrates an example of the voltage command values vᵤ*, vᵥ*, v_{w}determined by the coordinate converter 111.

The PWM signal generator 112 generates PWM signals UP, VP, UP, UN, VN, WN illustrated in FIG. 3C, from the input voltage V_{dc} and the voltage command values vᵤ*, vᵥ*, v_{w}.

The PWM signals UP, VP, UP, UN, VN, WN are supplied to the inverter 4 and used for control of the switching elements.

The inverter 4 is provided with a driving circuit (not illustrated) for generating, based on the PWM signals UP, VP, WP, UN, VN, WN, drive signals for driving the switching elements of the respective corresponding arms.

By controlling turning on and off of the switching elements of the inverter 4 based on the above PWM signals UP, VP, WP, UN, VN, WN, AC voltages with a variable frequency and a variable voltage value can be outputted from the inverter 4, and applied to the first motor 41 and the second motor 42.

In the example illustrated in FIG. 3B, the voltage command values vᵤ*, vᵥ*, v_{w}* are sinusoidal, but the voltage command values may be ones with a third harmonic wave superimposed, and they may be of any waveform as long as they can drive the first motor 41 and the second motor 42.

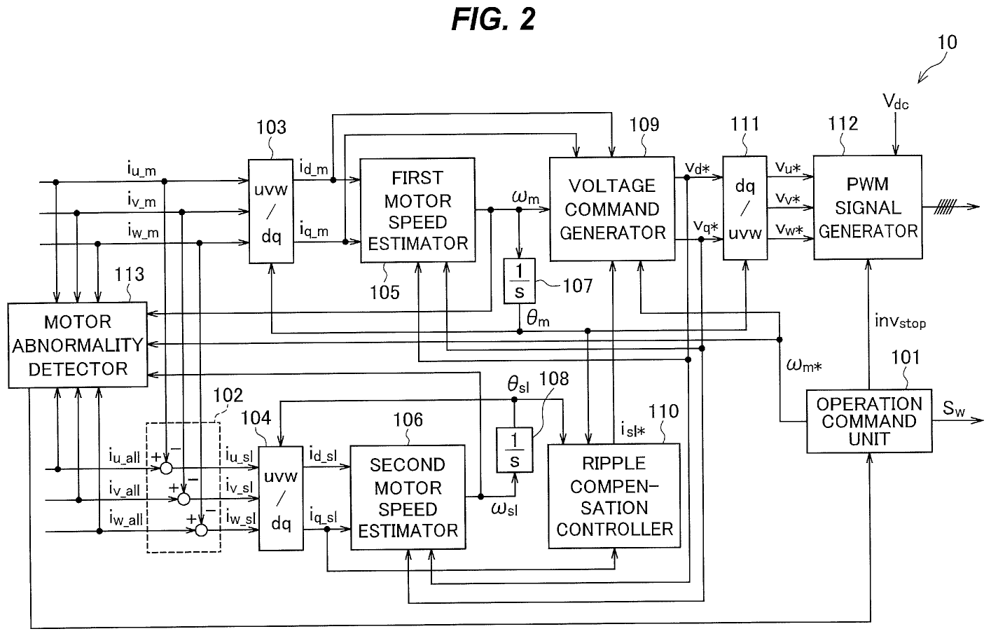

Returning to FIG. 2, if the voltage command generator 109 were configured to generate the voltage command based only on the dq-axis currents i_{d_m}, i_{q_m} and the rotational frequency estimated value ωₘ of the first motor 41, the first motor 41 would be controlled properly, but the second motor 42 would operate merely in accordance with the voltage command values generated for the first motor 41 without being directly controlled.

Thus, the first motor 41 and the second motor 42 would operate in a state in which there is a difference between the phase estimated value θₘ and the phase estimated value θₛₗ, and the difference would be significant especially in the low speed region.

The difference would cause ripple in the currents of the second motor 42, which might lead to step-out of the second motor 42 or increase of loss due to heat generation due to excessive current. Moreover, circuit interruption might be performed in response to excessive current, stopping the motors and preventing the load from being driven.

The ripple compensation controller 110 is provided to solve such problems, and outputs the ripple compensation current command value iₛₗ* for reducing the current ripple of the second motor 42, using the q-axis current i_{q_sk} of the second motor 42, the phase estimated value θₘ of the first motor 41, and the phase estimated value θₛₗ of the second motor 42.

The ripple compensation current command value iₛₗ* is determined to reduce ripple in the q-axis current i_{q_sl}, which corresponds to the torque current of the second motor 42, based on the phase relation between the first motor 41 and the second motor 42, which is determined based on the phase estimated value θₘ of the first motor 41 and the phase estimated value θₛₗ the second motor 42.

The voltage command generator 109 performs proportional-integral computation on the difference between the rotational frequency command value ωₘ* of the first motor 41 from the operation command unit 101 and the rotational frequency estimated value ω_{w} of the first motor 41, and determines a q-axis current command value of the first motor 41.

The d-axis current of the first motor 41 is an excitation current component, and, by varying its value, it is possible to control the current phase, and to drive the first motor 41 with flux strengthening or flux weakening. Taking advantage of such characteristics, it is possible to control the current phase by applying the above-mentioned ripple compensation current command value iₛₗ* to a d-axis current command value I_{d_m}* of the first motor 41, thereby reducing the ripple.

The voltage command generator 109 determines the dq-axis voltage command values v_{d}*, v_{q}* based on the dq-axis current command values I_{d_m}*, I_{q_m} determined as above and the dq-axis currents i_{d_m}, i_{q_m} determined by the coordinate converter 103. Specifically, it performs proportional-integral computation on the difference between the d-axis current command value I_{d_m}* and the d-axis current to determine the d-axis voltage command value and performs proportional-integral computation on the difference between the q-axis current command value I_{q_m}* and the q-axis current to determine the q-axis voltage command value v_{q}*.

The voltage command generator 109 and the ripple compensation controller 110 may be of any configuration as long as they can provide the same functions.

By performing the control described above, it is possible to drive the first motor 41 and the second motor 42 with the single inverter 4 without causing ripple in the second motor 42.

The motor abnormality detector 113 detects abnormalities in at least one of the first motor 41 and the second motor 42.

Firstly, an abnormality in the first motor 41 appears as an abnormality in the rotational frequency of the first motor 41, and an abnormality in the second motor 42 appears as an abnormality in the rotational frequency of the second motor 42. Thus, the motor abnormality detector 113 may detect abnormalities in the first motor 41 and the second motor 42 by monitoring the rotational frequency of the first motor 41 and the rotational frequency of the second motor 42.

For example, when a difference between the rotational frequency of the first motor 41 and the rotational frequency of the second motor 42 is greater than a predetermined threshold, the motor abnormality detector 113 can determine that there is an abnormality in the first motor 41 or the second motor 42. Specifically, when a difference between the rotational frequency estimated value ωₘ of the first motor 41 obtained from the first motor speed estimator 105 and the rotational frequency estimated value ωₛₗ of the second motor 42 obtained from the second motor speed estimator 106 is greater than a predetermined threshold, the motor abnormality detector 113 can determine that there is an abnormality in the first motor 41 or the second motor 42. In this case, the motor abnormality detector 113 can calculate a difference between the rotational frequency command value ωₘ* from the operation command unit 101 and the rotational frequency estimated value ωₘ of the first motor 41 and a difference between the rotational frequency command value ωₘ* from the operation command unit 101 and the rotational frequency estimated value ωₛₗ of the second motor 42, and detect that there is an abnormality in one of the motors having the greater of the differences. That is, when the difference between the rotational frequency of the first motor 41 and the rotational frequency of the second motor 42 is greater than the predetermined threshold, the motor abnormality detector 113 can detect that there is an abnormality in one or the motors whose amount of deviation from the rotational frequency commanded from the operation command unit 101 is greater than that of the other.

Also, the motor abnormality detector 113 can determine, when a deviation of the rotational frequency of the first motor 41 is greater than a predetermined threshold, that the first motor 41 is abnormal, and determine, when a deviation of the rotational frequency of the second motor 42 is greater than a predetermined threshold, that an abnormality has occurred in the second motor 42. Specifically, the motor abnormality detector 113 can calculate a deviation of the rotational frequency estimated value ωₘ of the first motor 41 obtained from the first motor speed estimator 105 and a deviation of the rotational frequency estimated value ωₛₗ of the second motor 42 obtained from the second motor speed estimator 106, and when one of the calculated deviations is greater than a predetermined threshold, detect an abnormality in the motor from which the deviation has been calculated.

Further, the motor abnormality detector 113 can detect that there is an abnormality in a motor whose amount of deviation from the rotational frequency commanded from the operation command unit 101 is greater than a predetermined threshold. Specifically, the motor abnormality detector 113 can compare the rotational frequency estimated value ωₘ of the first motor 41 obtained from the first motor speed estimator 105 and the rotational frequency command value ωₘ* from the operation command unit 101, and when a difference therebetween is greater than the threshold, detect an abnormality in the first motor 41. Also, the motor abnormality detector 113 can compare the rotational frequency estimated value ωₛₗ of the second motor 42 obtained from the second motor speed estimator 106 and the rotational frequency command value ωₘ* from the operation command unit 101, and when a difference therebetween is greater than the threshold, detect an abnormality in the second motor 42. The threshold. here i.s preferably equal to the rotational frequency command value θₘ*.

Secondly, an abnormality in the first motor 41 appears as an abnormality in the currents output from the inverter 4 to the first motor 41, and an abnormality in the second motor 42 appears as an abnormality in the currents output from The inverter 4 to the second motor 42. Thus, the motor abnormality detector 113 can detect abnormalities in the first motor 41 and the second motor 42 by monitoring the currents output from the inverter 4.

For example, when an overcurrent is detected from the phase currents i_{u_m}, i_{v_m}, i_{w_m} of the first motor 41, i.e., when the current value of any of the phase currents i_{u_m}, i_{v_m}, i_{w_m} of the first motor 41 is greater than a predetermined threshold, the motor abnormality detector 113 can detect that there is an abnormality in the first motor 41. Also, when an overcurrent is detected from the phase currents i_{u_sl}, i_{v_sl}, i_{w_sl} of the second motor 42, i.e., when the current value of any of the phase currents i_{u_sl}, i_{v_sl}, i_{w_sl} of the second motor 42 is greater than a predetermined threshold, the motor abnormality detector 113 can detect that there is an abnormality in the second motor 42. As described above, the phase currents i_{u_sl}, i_{v_sl}, i_{w_sl} of the second motor 42 can be obtained by subtracting the phase currents i_{u_m}, i_{v_m}, i_{w_m} of the first motor 41 from the inverter currents i_{u_all}, i_{v_all}, i_{w_all}.

When the motor abnormality detector 113 detects an abnormality, it transmits an abnormality signal indicating the motor in which the abnormality has been detected, to the operation command unit 101, thereby informing the operation command unit 101 of the motor in which the abnormality has been detected.

In the first embodiment, when an abnormality is detected in the first motor 41, the operation command unit 101 transmits an inverter stop signal invₛₜₒₚ to the PWM signal generator 112 to stop the switching in the inverter 4.

On the other hand, when an abnormality is detected in the second motor 42, the operation command unit 101 transmits, to the connection switching device 8, a switching control signal S_{w} to open the switch 9. Thus, the operation of the first motor 41 in a normal state is continued.

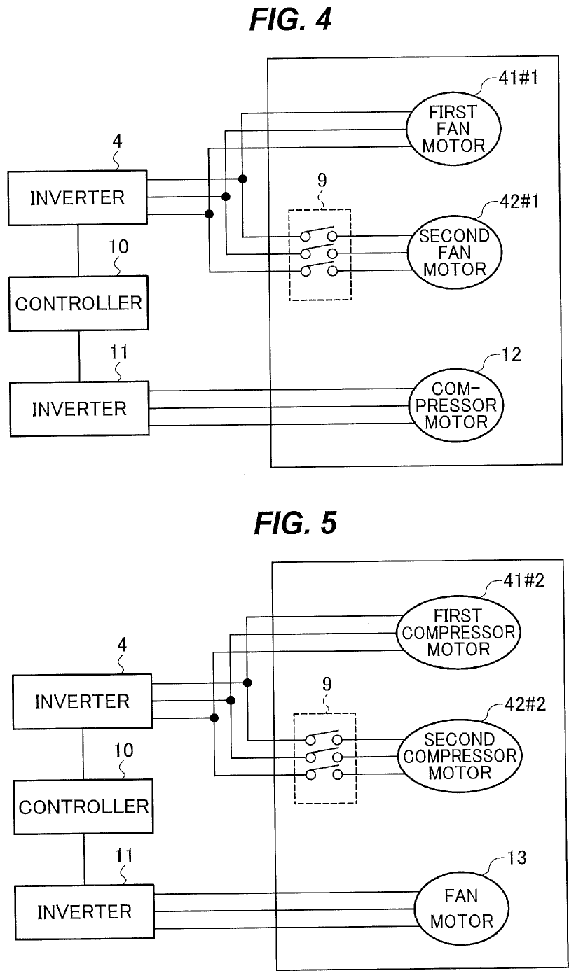

FIG. 4 is a schematic diagram illustrating a first usage example of the motor driver of the first embodiment.

In the first usage example, the motor driver of the first embodiment is used in an outdoor unit of an air conditioner as refrigeration cycle equipment.

As illustrated, a first fan motor 41#1 and a second fan motor 42#1 are connected to the single inverter 4, and a compressor motor 12 is connected to another inverter 11.

It is assumed that the other inverter 11 is also controlled by the controller 10. Since only the single compressor motor 12 is connected to the inverter 11, known techniques may be used for control of the inverter 11 by the controller 10.

Here, the first motor 41 illustrated in FIG. 1 is used as the first fan motor 41#1, and the second motor 42 is used as the second fan motor 42#1.

When an abnormality is detected in the first fan motor 41#1, the controller 10 stops the inverter 4.

When an abnormality is detected in the second fan motor 42#1, the controller 10 opens the switch 9 to stop the second fan motor 42#1. In this case, as the controller 10 increases the rotational frequency of the first fan motor 41#1, it also increases the rotational frequency of the compressor motor 12. This increases the heat exchange efficiency, and makes it possible, when continuing to operate only the first fan motor 41#1 in a normal state, to prevent the air-conditioned temperature from greatly changing compared to before stopping the second fan motor 42#1. Also, even when the rotational frequency of the first fan motor 41#1 reaches its limit as a maximum rotational frequency, it is possible to increase the heat exchange efficiency by increasing the rotational frequency of the compressor motor 12.

FIG. 5 is a schematic diagram illustrating a second usage example of the motor driver of the first embodiment.

In the second usage example, the motor driver of she first embodiment is used in an outdoor unit of an air conditioner.

As illustrated, a first compressor motor 41#2 and a second compressor motor 42#2 are connected to the single inverter 4, and a fan motor 13 is connected to another inverter 11.

It is assumed that the other inverter 11 is also controlled by the controller 10 using known techniques. Here, the first motor 41 illustrated in FIG. 1 is used as the first compressor motor 41#2, and the second motor 42 is used as the second compressor motor 42#2.

When an abnormality is detected in the first compressor motor 41#2, the controller 10 stops the inverter 4.

When an abnormality is detected in the second compressor motor 42#2, the controller 10 opens the switch 9 to stop the second compressor motor 42#2. In this case, as the controller 10 increases the rotational frequency of the first compressor motor 41#2, it also increases the rotational frequency of the fan motor 13. This increases the heat exchange efficiency, and makes it possible, when continuing to operate only the first compressor motor 41#2 in a normal state, to prevent the air-conditioned temperature from greatly changing compared to before stopping she second compressor motor 42#2. Also, even when the rotational f*frequency of the first compressor motor 41#2 reaches its limit at a maximum rotational frequency, it is possible to increase the heat exchange efficiency by increasing the rotational frequency of the fan motor 13.

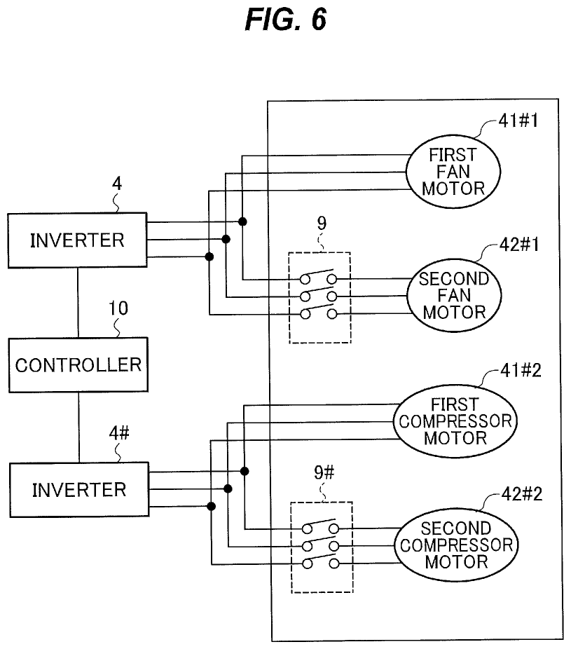

FIG. 6 is a schematic diagram illustrating a third usage example of the motor driver of the first embodiment.

In the third usage example, the motor driver of the first embodiment is used in an outdoor unit of an air conditioner.

As illustrated, a first fan motor 41#1 and a second fan motor 42#1 are connected to the single inverter 4.

Also, a first compressor motor 41#2 and a second compressor motor 42#2 are connected to a single inverter 4#.

It is assumed that the inverter 4# is configured in the same manner as the inverter 4 illustrated in FIG. 1, and controlled by the controller 10 in the same manner as the inverter 4 of FIG. 1. Here, the first motor 41 illustrated in FIG. 1 is used as the first fan motor 41#1, and the second motor 42 is used as the second fan motor 42#1. Also, in FIG. 6, a third motor that is the same as the first motor 41 of FIG. 1 is connected to the inverter 4#, and the third motor is used as the first compressor motor 41#2. Further, in FIG. 6, a fourth motor that is he same as the second motor 42 of FIG. 1 is connected to the inverter 4#, and the fourth motor is used as the second compressor motor 42#2.

Here, it is assumed that N (N being an integer not less than 2) motors are connected to the inverter 4, and each of the motors are rotating in accordance with a rotational frequency command value indicating a rotational frequency M (N being a positive integer). In this case, when anormality (ies) are detected in A (A being a positive integer and less than N) of the N motors, the operation command unit 101 disconnects the motor(s) in which the abnormality(ies) have been detected, continues to drive the normal motor(s), and increases the rotational frequency thereof.

In such a situation, the operation command unit 101 calculates the rotational frequency command value ωₘ* of the (N-A) motor (S) that are normally driven, by (M×N)/(N-A). However, when the value calculated by (M×N)/(N-A) is greater than a maximum rotational frequency of a motor, the operation command unit 101 determines the maximum rotational frequency of the motor as the rotational frequency command value ωₘ*.

An example will be described using the first usage example illustrated in FIG. 4. When an abnormality is detected in the second fan motor 42#1 that is rotating at 1000 rpm, the operation command unit 101 provides the first fan motor 41#1 in a normal state, with a rotational frequency command value ωₘ* indicating (1000×2)/(2-1)=2000 rpm. However, when a maximum rotational frequency of the first fan motor 41#1 is 1800 rpm, the operation command unit 101 provides the first fan motor 41#1 with a rotational frequency command value ωₘ* indicating 1800 rpm.

Next, the operation of the switch 9 illustrated in FIG. 1 will be described.

When the switch 9 is open, the inverter 4 outputs the voltages to only the first motor 41, and thus only the first motor 41 is rotated and driven. When the switch 9 is closed while the first motor 41 is being driven, since the second motor 42, which is a synchronous motor, is in a stopped state, the second motor 42 may fail to follow the AC voltages output by the inverter 4 and start. The operation command unit 101 can restart the second motor 42 by sufficiently decreasing the rotational frequency of the first motor 41 and then closing the switch 9 to start the second motor 42, or by stopping the first motor 41 once and then closing the switch 9 and starting the second motor 42.

The following describes an operation of, when the first motor 41 and the second motor 42 are being driven with the switch 9 closed, opening the switch 9 and operating only the first motor 41.

When the switch 9 is opened while the second motor 42 is being driven, since the current paths are broken, voltages are generated depending on the inductances of the second motor 42 and the currents flowing through the second motor 42, which may disable the switch 9. Also, in a case where a mechanical relay is used as the switch 9, when it is opened or closed while current is flowing, contact welding due to arcing may be caused. The operation command unit 101 can avoid the above concern by opening the switch 9 in a state where the rotational frequency of the second motor 42 has been sufficiently decreased (or stopped) or by opening the switch 9 in a state where the currents flowing through the second motor 42 are controlled at zero or values near zero, i.e., in a state where the currents flowing through the second motor 42 are not greater than a predetermined threshold, by commanding the voltage command generator 109.

For example, the voltage command generator 109 can control the currents flowing through the second motor 42 at zero or values near zero by setting the dq-axis current command values I_{d_m}, I_{q_m}* to indicate zero and determining the dq-axis voltage command values v_{d}*, v_{q}*, in accordance with the command from the operation command unit 101.

### Second Embodiment

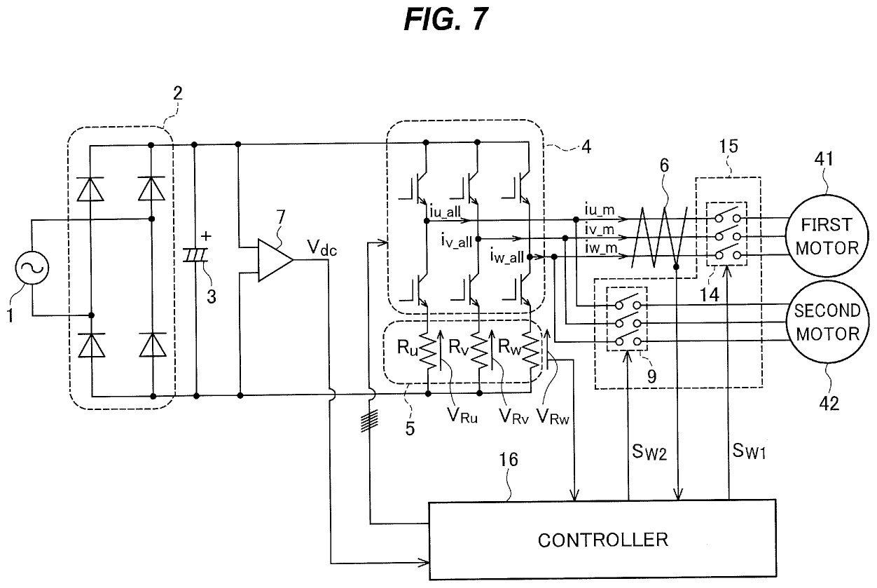

FIG. 7 is a schematic diagram illustrating a motor driver of a second embodiment.

The illustrated motor driver includes a rectifier 2, a smoothing device 3, an inverter 4, an inverter current detector 5, a motor current detector 6, an input voltage detector 7, a connection switching device 15, and a controller 16.

The motor driver illustrated in FIG. 7 is configured in the same manner as the motor driver illustrated in FIG. 1, except for the connection switching device 15 and the controller 16.

The connection switching device 15 is constituted by two switches 9, 14.

The switch 9 is the same as in the first embodiment, and is capable of connecting and disconnecting the second motor 42 to and from the inverter 4.

The switch 14 is capable of connecting and disconnecting the first motor 41 to and from the inverter 4.

By opening and closing the switches 9, 14, the number of the motors which are concurrently operated can be changed.

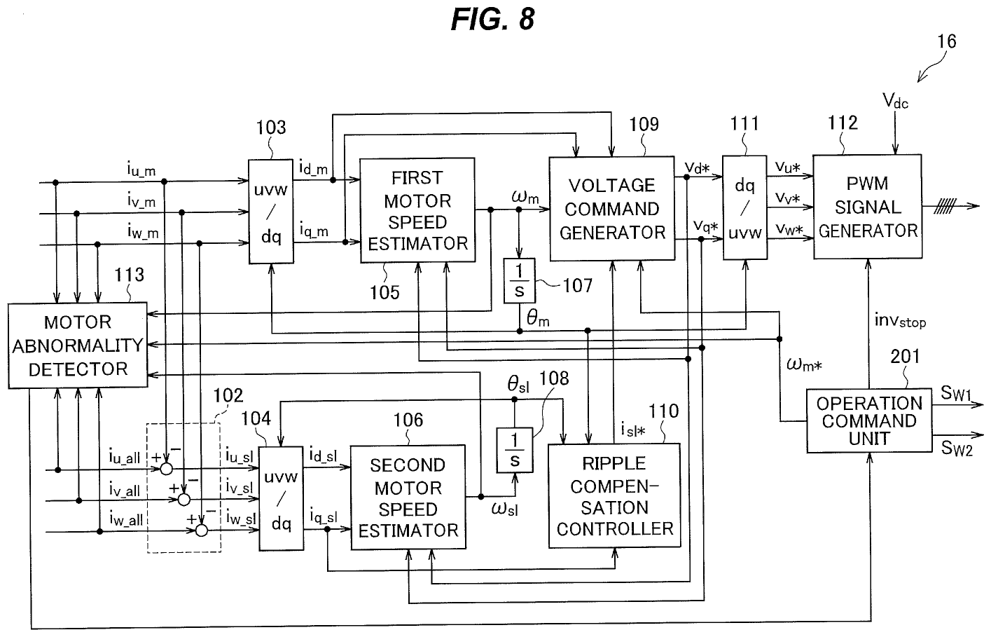

FIG. 8 is a functional block diagram illustrating a configuration of the controller 16.

As illustrated, the controller 16 includes an operation command unit 201, a subtractor 102, coordinate converters 103, 104, speed estimators 105, 106, integrators 107, 108, a voltage command generator 109, a ripple compensation controller 110, a coordinate converter 111, a PWM signal generator 112, and a motor abnormality detector 113.

The controller 16 illustrated in FIG. 8 is configured in the same manner as the controller 10 illustrated in FIG. 2, except for the operation command unit 201.

The operation command unit 201 generates and outputs a rotational frequency command value ωₘ* for the motors. The operation command unit 201 also generates and outputs switching control signals S_{w1}, S_{w2} for controlling the connection switching device 15.

For example, while the first motor 41 and the second motor 42 are being driven, when the motor abnormality detector 113 detects an abnormality in the first motor 41, the operation command unit 201 transmits, to the connection switching device 15, a switching control signal S_{w1} to open the switch 14.

Also, while the first motor 41 and the second motor 42 are being driven, when the motor abnormality detector 113 detects an abnormality in the second motor 42, the operation command unit 201 transmits, to the connection switching device 15, a switching control signal S_{w2} to open the switch 9.

Thereby, when an abnormality is detected in the first motor 41 but the second motor 42 is normal, the operation command unit 201 can disconnect the first motor 41 by means of the connection switching device 15 and continue to operate only the second motor 42.

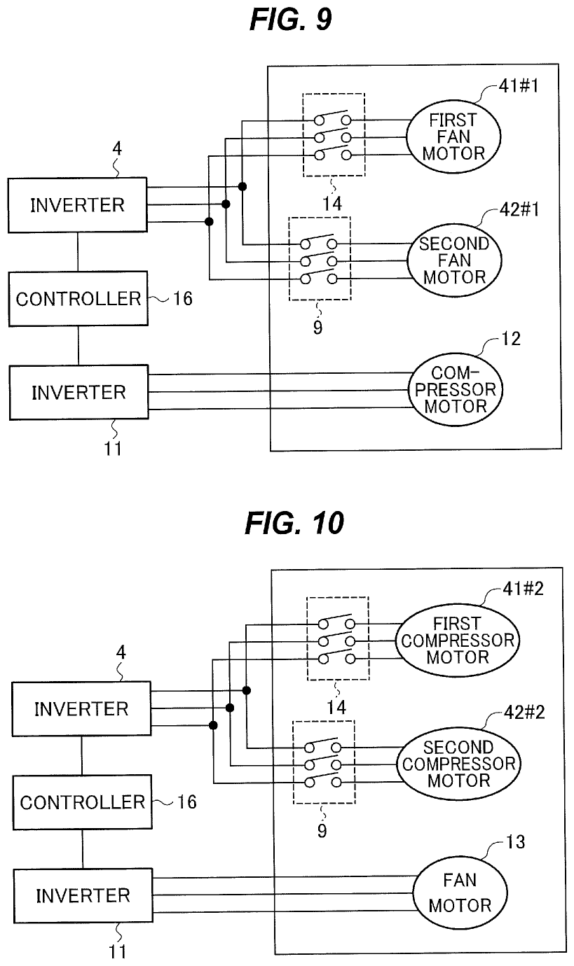

FIG. 9 is a schematic diagram illustrating a first usage example of the motor driver of the second embodiment.

In the first usage example, the motor driver of the second embodiment is used in an outdoor unit of an air conditioner.

As illustrated, a first fan motor 41#1 and a second fan motor 42#1 are connected to the single inverter 4, and a compressor motor 12 is connected to another inverter 11.

It is assumed that the other inverter 11 is also controlled by the controller 16. Since only the single compressor motor 12 is connected to the inverter 11, known techniques may be used for control of the inverter 11 by the controller 16.

Here, the first motor 41 illustrated in FIG. 7 is used as the first fan motor 41#1, and the second motor 42 is used as the second fan motor 42#1.

When an abnormality is detected in the first fan motor 41#1, the controller 16 opens the switch 14 to stop the first fan motor 41#1. In this case, as the controller 16 increases the rotational frequency of the second fan motor 42#1, it also increases the rotational frequency of the compressor motor 12.

Also, when an abnormality is detected in the second fan motor 42#1, the controller 16 opens the switch 9 to stop the second fan motor 42#1. In this case, as the controller 16 increases the rotational frequency of the first fan motor 41#1, it also increases the rotational frequency of the compressor motor 12.

This increases the heat exchange efficiency, and makes it possible, when continuing to operate only the second fan motor 42#1 or the first fan motor 41#1 in a normal state, to prevent the air-conditioned temperature from greatly changing compared to before stopping the first fan motor 41#1 or the second fan motor 42#1. Also, even when the rotational frequency of the second fan motor 42#1 or the first fan motor 41#1 reaches its limit at a maximum rotational frequency, it is possible to increase the heat exchange efficiency by increasing the rotational frequency of the compressor motor 12.

FIG. 10 is a schematic diagram illustrating a second usage example of the motor driver of the second embodiment.

In the second usage example, the motor driver of the second embodiment is used in an outdoor unit of an air conditioner.

As illustrated, a first compressor motor 41#2 and a second compressor motor 42#2 are connected to the single inverter 4, and a fan motor 13 is connected to another inverter 11.

It is assumed that the other inverter 11 is also controlled by the controller 16 using known techniques. Here, the first motor 41 illustrated in FIG. 7 is used as the first compressor motor 41#2, and the second motor 42 is used as the second compressor motor 42#2.

Here, when an abnormality is detected in the first compressor motor 41#2, the controller 16 opens the switch 14 to stop the first compressor motor 41#2. In this case, as the controller 16 increases the rotational frequency of the second compressor motor 42·2, it also increases the rotational frequency of the fan motor 13.

Also, when an abnormality is detected in the second compressor motor 42#2, the controller 16 opens the switch 9 to stop the second compressor motor 42#2. In this case, as the controller 16 increases the rotational frequency of the first compressor motor 41#2, it also increases the rotational frequency of the fan motor 13.

This increases the heat exchange efficiency, and makes it possible, when continuing to operate only the second compressor motor 42#2 or the first compressor motor 41#2 in a normal state, to prevent the air-conditioned temperature from greatly changing compared to before stopping she first compressor motor 41#2 or the second compressor motor 42#2. Also, even when the rotational frequency of the first compressor motor 41#2 or the second compressor motor 42#2 reaches its limit at a maximum rotational frequency, it is possible to increase the heat exchange efficiency by increasing the rotational frequency of the fan motor 13.

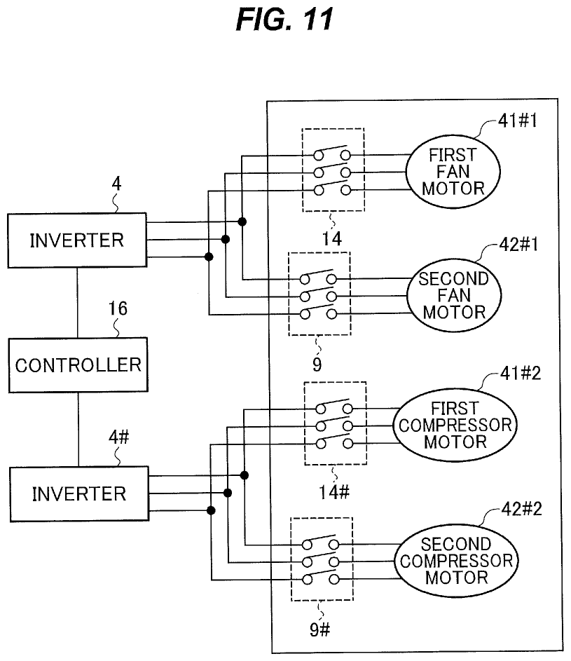

FIG. 11 is a schematic diagram illustrating a third usage example of the motor driver of the second embodiment.

In the third usage example, the motor driver of the second embodiment is used in an outdoor unit of an air conditioner.

As illustrated, a first fan motor 41#1 and a second fan motor 42#1 are connected to the single inverter 4.

Also, a first compressor motor 41#2 and a second compressor motor 42#2 are connected to a single inverter 4#.

It is assumed that the inverter 4# is configured in the same manner as the inverter 4 illustrated in FIG. 7, and controlled by the controller 16 in the same manner as the inverter 4 of FIG. 7. Here, the first motor 41 illustrated in FIG. 7 is used as the first fan motor 41#1, and the second motor 42 is used as the second fan motor 42#1. Also, in FIG. 11, a third motor that is the same as the first motor 41 of FIG. 7 is connected to the inverter 4#, and the third motor is used as the first compressor motor 41#2. Further, in FIG. 11, a fourth motor that is the same as the second motor 42 of FIG. 7 is connected to the inverter 4#, and the fourth motor is used as the second compressor motor 42#2.

### Third Embodiment

In a third embodiment, an example of a circuit configuration of a heat pump apparatus as refrigeration cycle equipment will be described.

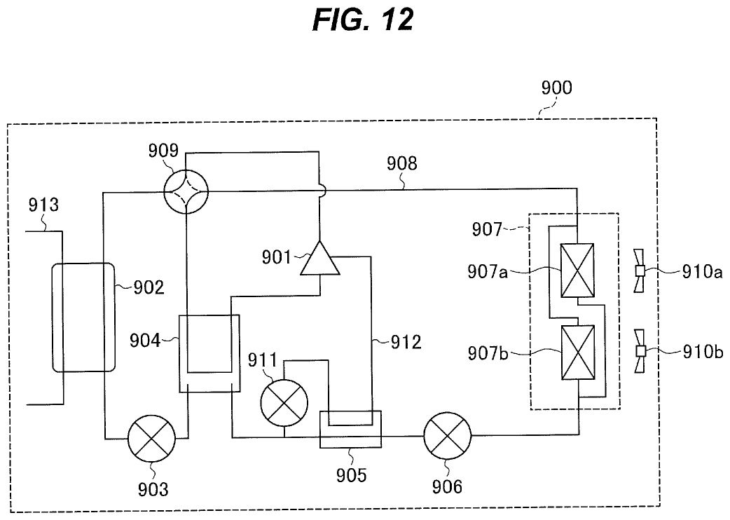

FIG. 12 is a circuit configuration diagram of a heat pump apparatus 900 according so the third embodiment.

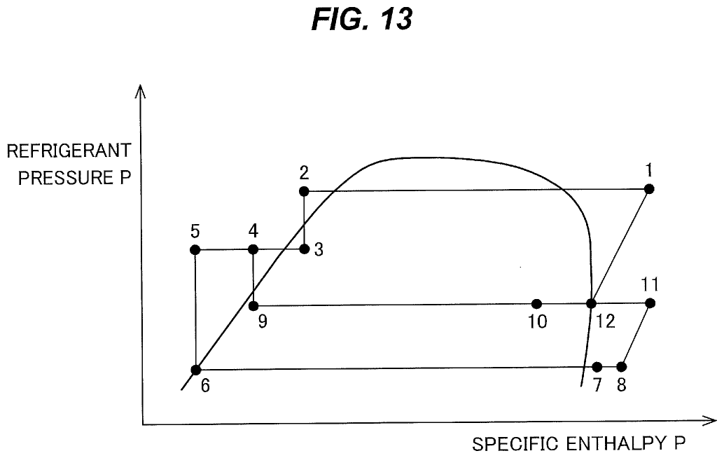

FIG. 13 is a Mollier chart concerning the state of a refrigerant in the heat pump apparatus 900 illustrated in FIG. 12. In FIG. 13, the horizontal axis represents the specific enthalpy, while the vertical axis represents the refrigerant pressure.

The heat pump apparatus 900 includes a main refrigerant circuit 908 in which a compressor 901, a heat exchanger 902, an expansion mechanism 903, a receiver 904, an internal heat exchanger 905, an expansion mechanism 906, and a heat exchanger 907 are sequentially connected by piping, and in which the refrigerant circulates. In the main refrigerant circuit 908, a four-way valve 909 is provided on the discharge side of the compressor 901 to allow the direction of the circulation of the refrigerant to be changed.

The heat exchanger 907 has a first part 907a and a second part 907b, to which valves (not illustrated) are connected to control the flow of the refrigerant according to the load of the heat pump apparatus 900. For example, when the load of the heat pump apparatus 900 is relatively high, the refrigerant is allowed to flow through both of the first part 907a and the second part 907b. When the load of the heat pump apparatus 900 is relatively low, the refrigerant is allowed to flow through only one of the first part 907a and the second part 907b, e.g., only the first part 907a.

Fans 910a and 910b are disposed near the first part 907a and the second part 907b, respectively corresponding to the first part 907a and the second part 907b. The fans 910a and 910b are driven by respective separate motors. For example, the motors 41 and 42 described in the first or second embodiment are used to drive the fans 910a and 910b, respectively.

The heat pump apparatus 900 further includes an injection circuit 912 connecting, by means of piping, from between the receiver 904 and the internal heat exchanger 905 to an injection pipe of the compressor 901. An expansion mechanism 911 and the internal heat exchanger 905 are sequentially connected in the injection circuit 912.

A water circuit 913, in which water circulates, is connected to the heat exchanger 902. A device using water, such as a hot water dispenser, a radiator, a heat radiator for floor heating or the like is connected to the water circuit 913.

First, the operation of the heat pump apparatus 900 in heating operation will be described. In the heating operation, the four-way valve 909 is set in the direction of the solid lines. Here, the heating operation includes not only heating used in air conditioning, but also water heating for hot water supply.

A gas-phase refrigerant made to have a high temperature and a high pressure at the compressor 901 (point 1 in FIG. 13) is discharged from the compressor 901, and is liquefied by heat exchange at the heat exchanger 902 serving as a condenser and a heat radiator (point 2 in FIG. 13). At this time, water circulating in the water circuit 913 is heated by heat from the refrigerant, and used for air heating, hot water supply, or the like.

The liquid-phase refrigerant liquefied at the heat exchanger 902 is decompressed as the expansion mechanism 903 into a gas-liquid two-phase state (point 3 FIG. 13). The refrigerant turned into the gas-liquid two-phase state at the expansion mechanism 903 is cooled and liquefied by heat exchange at the receiver 904 with the refrigerant to be drawn into the compressor 901 (point 4 in FIG. 13). The liquid-phase refrigerant liquefied at the receiver 904 branches and flows into the main refrigerant circuit 908 and the injection circuit 912.

The liquid-phase refrigerant flowing in the main refrigerant circuit 908 is further cooled by heat exchange at the internal heat exchanger 905 with the refrigerant flowing in the injection circuit 912 after being decompressed at the expansion mechanism 911 into a gas-liquid two-phase state (point 5 in FIG. 13). The liquid-phase refrigerant cooled at the internal heat exchanger 905 is decompressed at the expansion mechanism 906 into a gas-liquid two-phase state (point 6 in FIG. 13). The refrigerant turned into the gas-liquid two-phase state at the expansion mechanism 906 is heated by heat exchange with the outdoor air at the heat exchanger 907 serving as an evaporator (point 7 in FIG. 13).

The refrigerant heated at the heat exchanger 907 is further heated at the receiver 904 (point 8 FIG. 13), and is drawn into the compressor 901.

Meanwhile, the refrigerant flowing in the injection circuit 912 is decompressed at the expansion mechanism 911 (point 9 in FIG. 13), and subjected to heat exchange at the internal heat exchanger 905 (point 10 in FIG. 13) , as described above. The refrigerant (injection refrigerant) in the gas-liquid two-phase state subjected to heat exchange at the internal heat exchanger 905 flows through the injection pipe of the compressor 901 into the compressor 901 while keeping the gas-liquid two-phase state.

In the compressor 901, the refrigerant drawn from the main refrigerant circuit 908 (point 8 in FIG. 13) is compressed to an intermediate pressure and heated (point 11 in FIG. 13).

The refrigerant compressed to the intermediate pressure and heated (point 11 in FIG. 13) is mixed with the injection refrigerant (point 10 in FIG. 13) and decreases in temperature (point 12 in FIG. 13).

The refrigerant with its temperature lowered (point 12 in FIG. 13) is further compressed and heated to a high temperature and a high pressure, and is discharged (point 1 in FIG. 13).

When the injection operation is not performed, the opening degree of the expansion mechanism 911 is set to a fully closed state. Specifically, when the injection operation is performed, the opening degree of the expansion mechanism 911 is larger than a certain value. When the injection operation is not performed, the opening degree of the expansion mechanism 911 is smaller than the above certain value. Thereby, no refrigerant flows into the injection pipe of the compressor 901.

The opening degree of the expansion mechanism 911 is electronically controlled by a controller formed by a microcomputer or the like.

Next, the operation of the heat pump apparatus 900 in cooling operation will be described. In the cooling operation, the four-way valve 909 is set in the direction of the dashed lines. Here, the cooling operation includes not only cooling used in air conditioning, but also cooling of water, freezing of foods, and the like.

A gas-phase refrigerant made to have a high temperature and a high pressure at the compressor 901 (point 1 in FIG. 13) is discharged from the compressor 901, and is liquefied by heat exchange at the heat exchanger 907 serving as a condenser and a heat radiator (point 2 in FIG. 13). The liquid-phase refrigerant liquefied at the heat exchanger 907 is decompressed at the expansion mechanism 906 into a gas-liquid two-phase state (point 3 in FIG. 13). The refrigerant turned into the gas-liquid two-phase state at the expansion mechanism 906 is cooled and liquefied by heat exchange at the internal heat exchanger 905 (point 4 in FIG. 13). At the internal heat exchanger 905, heat is exchanged between the refrigerant turned into the gas-liquid two-phase state at the expansion mechanism 906 and the refrigerant in a gas-liquid two-phase state obtained by decompression at the expansion mechanism 911 of the liquid-phase refrigerant liquefied at the internal heat exchanger 905 (point 9 in FIG. 13). The liquid-phase refrigerant subjected to heat exchange at the internal heat exchanger 905 (point 4 in FIG. 13) branches and flows into the main refrigerant circuit 908 and the injection circuit 912.

The liquid-phase refrigerant flowing in the main refrigerant circuit 908 is further cooled by heat exchange at the receiver 904 with the refrigerant to be drawn into the compressor 901 (point 5 in FIG. 13). The liquid-phase refrigerant cooled at she receiver 904 is decompressed at the expansion mechanism 903 into a gas-liquid two-phase state (point 6 in FIG. 13). The refrigerant turned into the gas-liquid two-phase state at the expansion mechanism 903 is heated by heat exchange at the heat exchanger 902 serving as an evaporator (point 7 in FIG. 13). At this time, water circulating in the water circuit 913 is cooled by heat absorption by the refrigerant, and used for air cooling, cooling, freezing, or the like.

The refrigerant heated at the heat exchanger 902 is further heated at the receiver 904 (point 8 in FIG. 13), and is drawn into the compressor 901.

Meanwhile, the refrigerant flowing in the injection circuit 912 is decompressed at the expansion mechanism 911 (point 9 in FIG. 13), and subjected to heat exchange at the internal heat exchanger 905 (point 10 in FIG. 13), as described above. The refrigerant (injection refrigerant) in the gas-liquid two-phase state subjected to the heat exchange at the internal heat exchanger 905 flows in through the injection pipe of the compressor 901, while keeping the gas-liquid two-phase state.

The compression operation in the compressor 901 is the same as in the heating operation.

When the injection operation is not performed, the opening degree of the expansion mechanism 911 is set to a fully closed state to prevent the refrigerant from flowing into the injection pipe of the compressor 901, as in the case of the heating operation.

In the above example, the heat exchanger 902 is described to be a heat exchanger, such as a plate-type heat exchanger, that allows heat exchange between the refrigerant and water circulating in the water circuit 913. The heat exchanger 902 is not limited to this, but may be one that allows heat exchange between the refrigerant and air.

Also, the water circuit 913 is not limited to a circuit in which water circulates, but may be one in which another fluid circulates.

In the above example, the heat exchanger 907 has the first part 907a and the second part 907b. As an alternative, or in addition, the heat exchanger 902 may have two parts. When the heat exchanger 902 allows heat exchange between the refrigerant and air, it is possible that the two parts have respective fans, and the fans are driven by separate motors.

The above describes a configuration in which the heat exchanger 902 or 907 has two parts. As an alternative, or in addition, the compressor 901 may have a first part (first compression mechanism) and a second part (second compression mechanism). In such a case, control is made so that, when the load of the heat pump apparatus 900 is relatively high, both of the first part and the second part perform the compression operation, and when the load of the heat pump apparatus 900 is relatively low, only one of the first part and the second part, e.g., only the first part, performs the compression operation.

In the case or such a configuration, the first part and the second part of the compressor 901 are provided with separate motors for driving them. For example, the motors 41 and 42 described in the first or second embodiment are respectively used for driving the first part and the second part.

Although the above describes cases in which at least one of the heat exchangers 902 and 907 has two parts and is provided with two fans, a configuration in which a heat exchanger has three or more parts is also conceivable. In generalization, a configuration is conceivable in which at least one of the heat exchangers 902 and 907 has multiple parts, fans are provided for the respective parts, and motors are provided for the respective fans. In such a case, the multiple motors can be driven by a single inverter by using the motor driver described in the first or second embodiment.

Also, although the above describes a case in which the compressor 901 has two parts, a configuration in which the compressor 901 has three or more parts is conceivable. In generalization, a configuration is conceivable in which the compressor 901 has multiple parts, and motors are provided for the respective parts. In such a case, the multiple motors can be driven by a single inverter by using the motor driver described in the first or second embodiment.

In the above-described first embodiment, two motors are connected to the inverter 4, as illustrated in FIG. 1. However, three or more motors may be connected to the inverter 4. When three or more motors are connected to the inverter 4, a switch that is the same as the switch 9 may be provided between each of all the motors and the inverter 4. Alternatively, a switch that is the same as the switch 9 may be provided between each of a subset of the motors and the inverter 4. In these cases, the multiple switches constitute the connection switching device 8.

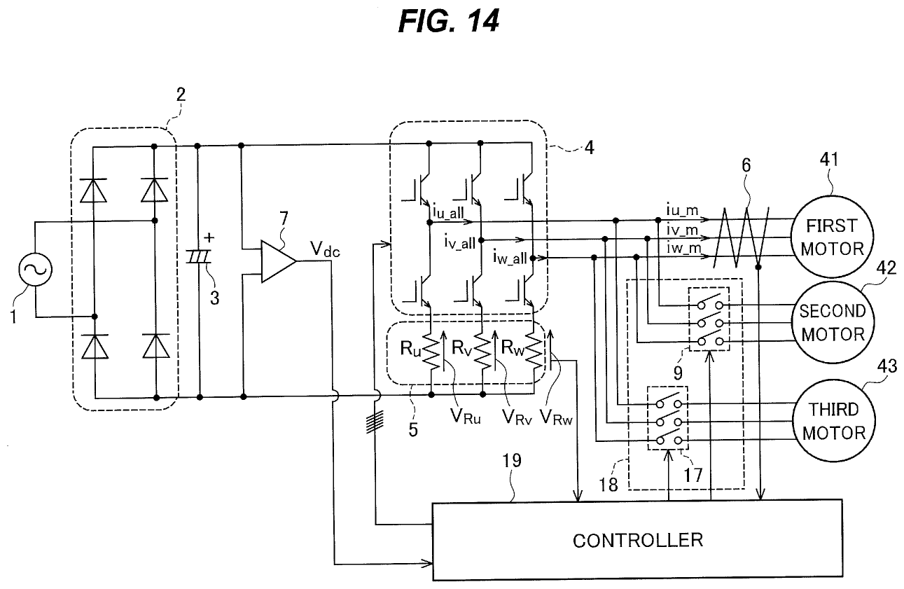

FIG. 14 is a schematic diagram illustrating an example of a case where three motors are connected to the inverter 4.

As illustrated in FIG. 14, a first motor 41, a second motor 42, and a third motor 43 are connected to the inverter 4. A switch 17 that is the same as the switch 9 is provided between the third motor 43 and the inverter 4. Thus, a connection switching device 18 includes the two switches 9, 17.

For example, when an abnormality is detected in the first motor 41, a controller 19 stops the inverter 4; when an abnormality is detected in the second motor 42, the controller 19 disconnects the connection between the second motor 42 and the inverter 4 to stop driving of the second motor 42; when an abnormality is detected in he third motor 43, the controller 19 disconnects the connection between the third motor 43 and the inverter 4 to stop driving of the third motor 43.

As above, in a motor driver including an inverter connected to n motors each including a rotor having a permanent magnet and capable of driving the n motors, and a connection switching device that switches a connection state of at least one of the n motors and the inverter between connection and disconnection, while the n motors are connected to the inverter and driven by the inverter, when an abnormality is detected in the at least one motor, the connection switching device switches the connection state to the disconnection and the inverter drives the n motors except the at least one motor. Thereby, it is possible to continue to operate motor(s) in which no abnormality has occurred.

Also, when the inverter drives the n motors except the at least one motor, the inverter increases the rotational frequency compared to when the inverter drives the n motors. Thereby, it is possible to compensate for the power of the stopped motor(s) with the other motor(s).

Also, the inverter allocates the rotational frequency at which the stopped motor(s) were driven, to the other motor(s). Thereby, it is possible to compensate for the power of the stopped motor(s) with the other motor(s).

However, when the rotational frequency of the other motor(s) is greater than a maximum rotational frequency of the other motor(s) after the rotational frequency at which the stopped motor(s) were driven is allocated to the other motor(s), the inverter drives the other motor(s) at the maximum rotational frequency. Thereby, it is possible to prevent failure of the other motor(s) or the like.

Also, when the inverter stops a motor and drives another motor, it drives the other motor at a maximum rotational frequency. Thereby, it is possible to compensate for the power of the stopped motor with the other motor.

Also, when a difference between the rotational frequency of a certain motor and the rotational frequency of another motor is greater than a predetermined first threshold, an abnormality is detected in the certain motor. Thereby, it is possible to reliably detect abnormalities in the motor.

For example, when a difference between an estimated rotational frequency that is an estimated value of the rotational frequency of the certain motor and a command rotational frequency that is a command value of the rotational frequency of the certain motor is greater than the first threshold, a controller for controlling the inverter and the connection switching device detects an abnormality in the certain motor. Thereby, it is possible to reliably detect abnormalities in the motor.

Also, when a deviation of an estimated rotational frequency that is an estimated value of the rotational frequency of a certain motor is greater than a predetermined second threshold, a controller for controlling the inverter and the connection switching device detects an abnormality in the certain motor. Thereby, it is possible to reliably, detect abnormalities in the motor.

Further, when a current value of at least one phase current of a certain motor is greater than a predetermined third threshold, a controller for controlling the inverter and the connection switching device detects an abnormality in the certain motor. Thereby, it is possible to reliably detect abnormalities in the motor.

The connection switching device is formed by wide-bandgap semiconductor. This makes it possible to reduce the loss and increase the switching speed.

Also, the connection switching device is formed by an electromagnetic contactor, and thereby can be implemented with a simple configuration.

A switching element or a freewheeling diode constituting the inverter is formed by wide-bandgap semiconductor. This makes it possible to reduce the loss and increase the switching speed.

Refrigeration cycle equipment includes the motor driver described in the first or second embodiment. This makes it possible, in the refrigeration cycle equipment, to stop a motor in which an abnormality has occurred, and continue driving of a motor in which no abnormality has occurred.

Here, a heat exchanger of the refrigeration cycle equipment includes n parts, the n motors are provided to correspond one-to-one to the n parts, a subset of the n parts that performs heat exchange operation is changed depending on a load of the refrigeration cycle equipment, and each of the n motors is driven by the inverter when the part of the heat exchanger corresponding to the motor performs heat exchange operation. Thereby, in the refrigeration cycle equipment, it is possible to stop a motor in which an abnormality has occurred, and continue driving of a motor in which no abnormality has occurred.

The n motors are used to rotate n fans provided to correspond to the n parts. Thereby, it is possible to stop a fan in which an abnormality has occurred, and continue driving of a fan in which no abnormality has occurred.

The refrigeration cycle equipment includes n compressors, the n motors are provided to correspond one-to-one to the n compressors, a subset of the n compressors that performs compression operation is changed depending on a load of the refrigeration cycle equipment, and each of the n motors is driven by the inverter when one of the n compressors corresponding to the motor performs compression operation. Thereby, it is possible to stop a compressor in which an abnormality has occurred, and continue driving of a compressor in which no abnormality has occurred.

1. A motor driver comprising:
an inverter connected to n motors each including a rotor having a permanent magnet and capable of driving the n motors, n being an integer not less than 2; and
a connection switching device to switch a connection state of at least one of the n motors and the inverter between connection and disconnection,
wherein while the n motors are connected to the inverter and driven by the inverter, when an abnormality is detected in the at least one motor, the connection switching device switches the connection state to the disconnection and the inverter drives the n motors except the at least one motor, and
wherein when the inverter drives the n motors except the at least one motor, the inverter increases a rotational frequency compared to when the inverter drives the n motors.

2. (canceled)

3. The motor driver of claim 1, wherein the inverter allocates a rotational frequency at which the at least one motor was driven, to the n motors except the at least one motor.

4. The motor driver of claim 3, wherein when a rotational frequency of the n motors except the at least one motor after the allocation of the rotational frequency at which the at least one motor was driven is greater than a maximum rotational frequency, the inverter drives the n motors except the at least one motor at the maximum rotational frequency.

5. The motor driver of claim 1, wherein when the inverter drives the n motors except the at least one motor, the inverter drives the n motors except the at least one motor at a maximum rotational frequency of the n motors.

6. The motor driver of claim 1, wherein when a first difference that is a difference between a rotational frequency of the at least one motor and a rotational frequency of the n motors except the at least one motor is greater than a predetermined first threshold, an abnormality is detected in the at least one motor.

7. The motor driver of claim 6, further comprising a controller to control the inverter and the connection switching device,
wherein when a second difference that is a difference between an estimated rotational frequency that is an estimated value of the rotational frequency of the at least one motor and a command rotational frequency that is a command value of the rotational frequency of the at least one motor is greater than the first threshold, the controller detects an abnormality in the at least one motor.

8. The motor driver of claim 6, further comprising a controller to control the inverter and the connection switching device,
wherein when a deviation of an estimated rotational frequency that is an estimated value of the rotational frequency of the at least one motor is greater than a predetermined second threshold, the controller detects an abnormality in the at least one motor.

9. The motor driver of claim 6, further comprising a controller to control the inverter and the connection switching device,
wherein when a current value of at least one phase current of the at least one motor is greater than a predetermined third threshold, the controller detects an abnormality in the at least one motor.

10. The motor driver of claim 1, wherein the connection switching device is formed by wide-bandgap semiconductor.

11. The motor driver of claim 1, wherein the connection switching device is formed by an electromagnetic contactor.

12. The motor driver of claim 1, wherein a switching element or a freewheeling diode constituting the inverter is formed by wide-bandgap semiconductor.

13. Refrigeration cycle equipment comprising the motor driver of claim 1.

14. The refrigeration cycle equipment of claim 13, wherein
a heat exchanger of the refrigeration cycle equipment includes n parts,
the n motors are provided to correspond one-to-one to the n parts,
a subset of the n parts that performs heat exchange operation is changed depending on a load of the refrigeration cycle equipment, and
each of the n motors is driven by the inverter when the part of the heat exchanger corresponding to the motor performs heat exchange operation.

15. The refrigeration cycle equipment of claim 14, wherein the n motors are used to rotate n fans provided to correspond to the n parts.

16. The refrigeration cycle equipment of claim 13, wherein
the refrigeration cycle equipment includes n compressors,
the n motors are provided to correspond one-to-one to the n compressors,
a subset of the n compressors that performs compression operation is changed depending on a load of the refrigeration cycle equipment, and
each of the n motors is driven by the inverter when one of the n compressors corresponding to the motor performs compression operation.
